(19) United States
(12) Patent Application Publication
(10) Pub. No.: US 2017/0095965 A1
(43) Pub. Date: Apr. 6, 2017

(54) VULCANIZING MOLD FOR IDENTIFYING BLOWING-LIMIT VULCANIZATION DEGREE AND TEST APPARATUS INCLUDING THE SAME

(71) Applicant: Ueshima Seisakusho Co., Ltd., Tokyo (JP)

(72) Inventors: Chikao TOSAKI, Tokyo (JP); Hiroshi ISHII, Tokyo (JP)

(21) Appl. No.: 15/284,847

(22) Filed: Oct. 4, 2016

(30) Foreign Application Priority Data
Oct. 5, 2015 (JP) 2015-197328

(51) Int. Cl. B29C 49/78; B29C 49/80; B29C 33/10

(52) U.S. Cl. CPC B29C 49/786; B29C 33/10; B29C 49/80

(57) ABSTRACT

A vulcanizing mold includes an upper mold and a lower mold. At least the lower mold is provided with a cavity in which unvulcanized sample rubber is charged, heated, and subjected to press vulcanization, so as to be formed into a rubber specimen for blowing limit observation continuously changing in vulcanization degree in a longitudinal direction. The cavity is provided with a first cavity that changes in depth in the longitudinal direction and is for producing the rubber specimen, and additionally provided with a second cavity that connectedly extends from the first cavity and is a space in which a temperature sensor is disposed to plot a temperature rise curve of the sample rubber during the vulcanization.

### CROSS REFERENCE TO RELATED APPLICATIONS

This application claims priority to Japanese Application 2015-197328, filed Oct. 5, 2015, the contents of which are incorporated by reference herein.

### TECHNICAL FIELD

The present invention relates to a vulcanizing mold for identifying a blowing-limit vulcanization degree, a test apparatus including the same, and a test method, in particular to a vulcanizing mold for identifying a blowing-limit vulcanization degree suitably used in conducting a study on vulcanization conditions of a new material rubber in a development phase or in conducting a simulation of a new material rubber product, and to a test apparatus including the same.

### BACKGROUND

Since a rubber is a poor conductor of heat, when a thick rubber piece is heated from both surfaces, a thickness center portion shows a slow temperature rise as compared with a near-surface portion. In a press vulcanization step, in a production step of a rubber product, in which heat and pressure are applied to unvulcanized rubber that has been mixed with necessary fillers and compounding ingredients, if a press vulcanization process is ended while the thickness center portion showing the slow temperature rise is in what is called an “under-vulcanization” state in which the thickness center portion is insufficiently vulcanized, and a vulcanized rubber product is taken out from a decompressed vulcanization apparatus, fine bubbles (blowns) occurs in such an “under-vulcanized” portion. The existence of bubbles of such a kind becomes a cause of the occurrence of various kinds of defects in the use of the rubber product. In particular, if automobile tires containing the “under-vulcanized” portion where bubbles remain are shipped, the bubbles may induce a burst of the automobile tires at high-speed traveling, which requires a countermeasure.

In contrast, unnecessary extension of a time period for processing press vulcanization in order to prevent “under-vulcanization” not only causes a waste of thermal energy, a decline in a production rate, and the like, but also causes an extra heating process itself to degrade the material quality of rubber, leading to loss of various material properties. Therefore, it is necessary to suppress the press vulcanization time period to the minimum requirement.

Thus, also for the thickness center portion prone to suffer insufficient vulcanization based in a heat transfer delay, it is very useful to measure and identify a minimum necessary vulcanization degree that gives vulcanized rubber containing no bubbles having an influence on a quality, that is, a blowing-limit vulcanization degree (hereafter, this will also be referred to as a blow point) in studying vulcanization conditions in a step of producing a new material rubber product, or in performing the simulation of a developed new material rubber product.

To develop a new material rubber product, a test for identifying a blow point, which is conducted for the study on vulcanization conditions and the like, is generally performed in conformity with the following procedure.

First, sample rubber is charged into a cavity of a wedge shape provided in a vulcanizing mold, the wedge shape having a gentle gradient, a temperature sensor is put in a predetermined thickness center portion of the sample rubber (the thickness is known) to plot an internal temperature rise of the sample rubber in a vulcanization process, and a vulcanized rubber specimen molded by the vulcanizing mold is obtained, the vulcanized rubber specimen gradually changing in thickness in a longitudinal direction.

Next, using a cutting machine, the thickness center plane of the vulcanized rubber specimen is exposed, and cross section observation is performed on a blowing state of the exposed thickness center plane. At this point, it is known that, with an increase in the thickness of the rubber specimen, larger bubbles are observed, and on the other hand, with a decrease in the thickness of the rubber specimen, finer bubbles are observed, “under-vulcanization” disappears eventually, and no bubbles can be confirmed. Consequently, a breaking point of the occurrence of confirmable fine bubbles, that is, a blowing limit site is identified, and thereafter, the thickness of the rubber specimen at the blowing limit site is calculated based on the length from a reference position to the blowing limit site, the thickness at the reference position, and the gradient of the rubber specimen.

Meanwhile, based on a temperature rise curve of the sample rubber that has been plotted during the vulcanization (hereafter, also referred to as a plotted temperature rise curve), a thermal diffusion constant χ of the sample rubber is determined, and using the value of the determined thermal diffusion constant χ, a temperature rise curve of sample rubber having a thickness equivalent to the thickness at the blowing limit site obtained through the above cross section observation (hereafter, also referred to as a calculated temperature rise curve) is calculated. Then, based on the calculated temperature rise curve of the sample rubber and the activation energy of the sample rubber that has been determined in advance, a reference temperature retention time period equivalent to a thermal history at the blowing limit site, that is, an equivalent vulcanization time period is calculated, and as will be described later, by applying the calculated equivalent vulcanization time period to a practical vulcanization degree curve of the sample rubber acquired from a curemeter separately, the blow point is identified.

The course of conducting a blow point identification test involves the following calculation processing according to what the Arrhenius equation on the temperature dependency of a vulcanization reaction rate, the theory of heat conduction, and “The replaceability of elastic modulus saturation to vulcanization degree”, and the like teach. Thus, the validity of the blow point identification test on a practical technology has been recognized in the rubber industry.

That is, the thermal diffusion constant χ is calculated as follows based on a plotted temperature rise curve and the theory of heat conduction.

Sample rubber of a wedge shape having a gentle gradient can be assumed to be a flat board, and thus a temperature rise curve at the thickness center point of the sample rubber that is uniformly heated from heat sources (a heating vulcanizing mold) on both surfaces of the sample rubber follows Expression (1), derived from the theory of heat conduction

$$α ( t ) = \frac{{T}_{2} - T ( t )}{{T}_{2} - {T}_{1}} = \frac{4}{π} exp [ - \frac{{π}^{2} x}{4 {h}^{2}} t ] \qquad ( 1 )$$

where T₁ denotes the initial temperature of the flat board, T₂ denotes the temperature of the heat sources brought into thermal contact with both surfaces of the flat board, α(t) denotes a temperature rise unsaturation degree of the flat board, h denotes a heat transfer distance to the thickness center point, being ½ thickness of the flat board, t denotes an elapsed time from the instant at which both surfaces of the flat board are brought into thermal contact with the heat sources, and χ denotes a thermal diffusion constant (mm²/sec), a value unique to the material of the flat board.

By taking the logarithm of Expression (1), Expression (2) is obtained.

ln α(t)=ln(4/π)−(π²χ/4h²)t (2)

As is clear from Expression (2), the relation between ln α(t) and an elapsed time t is a linear relation having a negative gradient. Therefore, the thermal diffusion constant χ is expressed by Expression (3).

χ=the negative gradient×4h²/π² (3)

In the process of conducting the blow point identification test, the thermal diffusion constant χ is calculated from Expression (2) and Expression (3) by applying, to Expression (1), a plotted temperature rise curve data obtained from the temperature sensor, and a thickness 2h of the sample rubber at a temperature measurement point.

Next, a calculated temperature rise curve of sample rubber having the same thickness as that of the blowing limit site can be calculated based on Expression (1) providing α(t), after substituting the thermal diffusion constant χ calculated by Expression (3) and the thickness of the blowing limit site identified from the cross section observation into Expression (2) to calculate ln α(t), and converting the calculated ln α(t) into α(t).

The equivalent vulcanization time period is calculated as follows.

The temperature dependency on the vulcanization reaction rate follows the Arrhenius equation, expressed by Expression (4)

k=A·exp[−Ea/RT] (4)

where k is a reaction rate constant, A is the frequency factor of the reaction, R is the gas constant, and Ea is an apparent activation energy.

By evaluating the time integral of the ratio between vulcanization reaction rates at a temperature T(t) changing with time and at a reference temperature (the temperature of the heat source) T₀ using the reaction rate ratio between temperatures obtained from Expression (4), a reference temperature retention time period equivalent to the temperature history T(t) (an equivalent vulcanization time period) t_{eq}(T₀) can be calculated by Expression (5). Note that t₁ denotes a heating start time point, and t₂ denotes a heating end time point.

$${t}_{eq} ( {T}_{0} ) = {\int }_{t 1}^{t 2} exp [ \frac{Ea}{R} ( \frac{1}{{T}_{0}} - \frac{1}{T ( t )} ) ] d t \qquad ( 5 )$$

When the reference temperature retention time period equivalent to the thermal history at the blowing limit site (the equivalent vulcanization time period) is calculated in the course of conducting the blow point identification test, by applying the calculated temperature rise curve of the sample rubber and the activation energy of the sample rubber that has been determined in advance, to Expression (5), the equivalent vulcanization time period is calculated.

Next, a practical vulcanization degree will be described.

In scientific terms, a vulcanization degree is a scale representing a vulcanization progression degree that is defined as a number density of network chains between cross-links formed between rubber polymer chains, whereas in practical terms, it is known that the vulcanization degree can be replaced with an elastic modulus saturation, an industrial scale. The elastic modulus saturation of this kind can be calculated by analyzing a vulcanization degree curve that is easily obtained using a curemeter.

FIG. 11 is a graph illustrating a practical vulcanization degree curve obtained using an oscillating curemeter described in JIS K 6300-2(2001) Part 2: Determination of cure characteristics with oscillating curemeters, issued by Japanese Standards Association, where the horizontal axis represents vulcanization time period, and the vertical axis represents torque amplitude for performing torsional mode vibration on a rubber specimen. It should be noted that a substantially linear relation is established between the practical vulcanization degree curve and the number density of network chains. This is the reason that the uses of an industrial scale (the elastic modulus saturation) in place of the vulcanization progression degree are widely practiced in rubber industry, the elastic modulus saturation being significantly easy to measure as compared with the vulcanization progression degree.

In FIG. 11, a symbol M_{E} denotes the total amount of vulcanization degree increments from a minimum torque M_{L} to a maximum torque M_{H}. Assuming that M(t) denotes the value of any point on the curve, the expression of the ratio of M(t)−M_{L} to M_{E} in percentage allows the vulcanization degree to be expressed by Expression (6).

Vulcanization degree=((M(t)−M_{L})/M_{E})*100% (6)

In such a technical background, to conduct a blow point identification test, a practical vulcanization degree curve of sample rubber is separately acquired using the curemeter, the sample rubber having the same material and the same combination as those of an object to be subjected to the blow point identification test, the practical vulcanization degree curve being acquired at the same reference temperature as that of the blow point identification test. Then, the equivalent vulcanization time period is calculated from Expression (5), the calculated equivalent vulcanization time period is applied to the practical vulcanization degree curve as illustrated in FIG. 11, whereby the blow point is identified. The blow point is calculated by Expression (6) because the blow point is an identification point on the vulcanization degree, a physical scale.

In such a blow point identification test, it is important to put the temperature sensor at the thickness center point of the sample rubber charged into the cavity in the vulcanizing mold (a sample charging space) as accurately as possible, so as to plot a temperature rise rate/temperature rise curve at a proper position faithfully, which in turn increases the accuracy of identifying the blow point of the sample rubber and the reproducibility of the test results.

When test apparatuses for identifying a blow point are classified according to putting methods of a temperature sensor, there are conventional apparatuses adopting what is called an embedding-sensor method in which a temperature sensor is sandwiched between pieces of sample rubber and collectively put in a cavity, and apparatuses adopting what is called an inserting-sensor method in which a piece of sample rubber is first charged into a cavity, and thereafter a temperature sensor is inserted into and put in the piece of sample rubber in the cavity. A known example of the apparatuses adopting the embedding-sensor method is a blowing-limit vulcanization degree test apparatus described in Japanese Patent No. 5154185. A known example of the apparatuses adopting the inserting-sensor method is a vulcanization degree distribution calculating test apparatus described in Japanese Patent Publication No. 07-018870.

First, the test apparatus described in Japanese Patent No. 5154185 will be described.

The test apparatus described in Japanese Patent No. 5154185 includes, as illustrated in FIGS. 12A to 12C, a vulcanizing mold 54 and a thin-rod-shaped temperature sensor 57. The vulcanizing mold 54 includes an upper mold 51 having a tightly-fit surface on which a wedge-shaped recessed portion 51a is provided having a rectangular shape in plan view, and a lower mold 52 having a tightly-fit surface on which a recessed portion 52a (having a shape symmetrical with the recessed portion 51a) is provided. When the upper mold 51 and the lower mold 52 are tightly fit with each other by a clamping mechanism (not illustrated), the recessed portions 51a and 52a facing each other are vertically joined to form a wedge shape cavity 53 that has a rectangular shape in plan view and a depth gradually changing in the longitudinal direction of the vulcanizing mold 54. The temperature sensor 57 includes a metal tubule 55 on the tube wall of which a plurality of hot junctions ch1 to ch4 are formed by a thermocouple wire housed in the metal tubule 55, the hot junctions ch1 to ch4 being separated from one another along the longitudinal direction of the metal tubule 55 and arranged on the depth center plane of the cavity 53, and measures the thickness center temperatures of the sample rubber 56 in the vulcanization process (at a plurality of spots different in the thickness of the sample rubber 56) in a chronological manner.

In the configuration described above, the embedding-sensor method is adapted to put the temperature sensor 57 into the cavity 53, as described above.

Specifically, the temperature sensor 57 is first sandwiched by pieces of unvulcanized sample rubber 56 manually, which is assembled to a frame body for loading (not illustrated) and retained in a room temperature state. Then, the assembled unvulcanized sample rubber 56, temperature sensor 57, and frame body are collectively placed in the recessed portion 52a of the lower mold 52 of the vulcanizing mold 54 regulated at a uniform vulcanization temperature (FIG. 12A). Thereafter, when the upper mold 51 and the lower mold 52 are clamped, and the unvulcanized sample rubber 56 is pressurized, the sample rubber 56 is totally buried in a gap in the cavity 53 due to the fluidity of unvulcanized rubber, and the press vulcanization reaction is started. A surplus of the sample rubber 56 flows out from the cavity 53 and flows into a flash groove. The sample rubber 56 charged into the cavity 53 have a thickness gradient in a longitudinal direction due to a shape giving the function of the cavity 53. In this apparatus, the hot junctions ch1 to ch4 of the temperature sensor 57 are held in the frame body so that when the frame body is loaded into the cavity 53, the hot junctions ch1 to ch4 are disposed on the thickness center line of the sample rubber 56 charged into the cavity 53 (FIG. 12B). Therefore, this configuration allows the temperature sensor 57 to plot the temperature rise curves of a plurality of sites that are inside the sample rubber 56 and in contact with the hot junctions ch1 to ch4 (i.e., a plurality of thickness center portions different in the thickness of the sample rubber 56), during the press vulcanization. After the end of the press vulcanization, a wedge-shaped rubber specimen 58 is taken out from the vulcanizing mold 54, the rubber specimen 58 gradually changing in thickness in the longitudinal direction (FIG. 12C).

Next, referring to FIG. 13, the test apparatus described in Japanese Patent Publication No. 07-018870 will be described.

FIG. 13 is a plan view illustrating a schematic configuration of the test apparatus described in Japanese Patent Publication No. 07-018870, schematically illustrating the disposition relationship between a cavity and temperature sensors.

This test apparatus also includes, as with the test apparatus described in the above Japanese Patent No. 5154185, a vulcanizing mold in which an upper mold and a lower mold are clamped to form a wedge-shaped cavity that has a rectangular shape in plan view and gradually changes in depth in the longitudinal direction. When unvulcanized sample rubber is charged into the cavity having such a shape and vulcanized, a rubber specimen for blowing limit observation having a thickness gradient is formed. This is also the same as the test apparatus described in Japanese Patent No. 5154185.

However, due to the difference in the putting method of a temperature sensor, the test apparatus described in Japanese Patent Publication No. 07-018870 has a configuration that is different from the test apparatus described in Japanese Patent No. 5154185 in the following points.

The test apparatus described in Japanese Patent Publication No. 07-018870 has a configuration supporting what is called the inserting-sensor method in which, as illustrated in FIG. 13, four thin-rod-shaped temperature sensors 59 to 62 are put into a cavity 63 and inserted into unvulcanized sample rubber 64, each of the temperature sensors 59 to 62 having a hot junction at its leading end portion. Therefore, as illustrated in FIG. 13, of the side walls of a lower mold 65, one of the side walls on the long sides is drilled to provide four through holes 66 to 69 in such a manner that the through holes 66 to 69 are coplanar and separate from one another. The four temperature sensors 59 to 62 are disposed in such a manner as to face the through holes 66 to 69, respectively, and inserted into the cavity 63 via the through holes 66 to 69 in an insertable and removable manner, following the operation of an air cylinder (not illustrated) and under the guidance of guide rods. Of the side walls of the lower mold 65, the other side wall on the long side is provided with vent holes 70 to 73 facing the through holes 66 to 69, the vent holes 70 to 73 allowing a surplus of the sample rubber to flow out of the mold.

Next, referring to FIG. 13, description will be made on the operation of the test apparatus described in Japanese Patent Publication No. 07-018870 at the time of starting vulcanization, in particular on the operation of putting the temperature sensors into the cavity of the vulcanizing mold.

First, when the upper mold and the lower mold 65 are clamped, the unvulcanized sample rubber 64 flows in the cavity 63 to be charged, whereby the vulcanization is started, and a surplus of the sample rubber 64 flows out of the mold via the vent holes 70 to 73. At the time when the flowing of the sample rubber 64 comes to an end, the air cylinder operates to make the four temperature sensors 59 to 62 move forward from their retracted positions. By the operation of the air cylinder, the hot junctions at the respective leading end portions of the temperature sensors 59 to 62 are horizontally inserted up to desired positions on the thickness center plane of the sample rubber 64 equivalent to the depth center plane of the cavity 63. While being inserted up to the desired positions, the four temperature sensors 59 to 62 measure the thickness center temperatures of the sample rubber 64 (at a plurality of spots different in thickness) in a chronological manner during the vulcanization.

### SUMMARY

However, it has been pointed out that the conventional, relevant apparatuses described above have the following problems.

First of all, there is a problem in that the temperature sensor is prone to suffer damage. Specifically, there is a disadvantage with the test apparatus described in Japanese Patent No. 5154185 adapting the embedding-sensor method in that, since the temperature sensor 57 is put into the cavity 53 collectively with the unvulcanized sample rubber 56, the unvulcanized sample rubber 56 strongly flows into a gap in the form of a viscoelastic flow with the clamping of the vulcanizing mold, and at this point, the thin-rod-shaped temperature sensor 57 is exposed to viscoelasticity hydrodynamic force to yield, deform, and consequently be bent sharply and broken.

In addition, after the end of the vulcanization, the temperature sensor 57 is manually pulled out from the vulcanized rubber specimen 58, when the temperature sensor 57 may be damaged due to a human error.

Next, there is also a disadvantage with the test apparatus described in Japanese Patent Publication No. 07-018870 adapting the inserting-sensor method in that, when the thin-rod-shaped temperature sensors 59 to 62 are inserted into the sample rubber 64 that is charged in a pressurizing manner charging, the temperature sensors 59 to 62 receive large insertion resistances from the sample rubber 64 having viscoelasticity, which causes the leading end portions thereof to deform and be bent because the outer diameter thereof is about 1 to 2 mm.

Even if the temperature sensors 59 to 62 do not result in breakage, the deformation of the temperature sensors 59 to 62 causes the hot junctions to measure the temperature rise at positions deviating from the thickness center portions of the sample rubber (i.e., the positions displaced to one of the heat sources), resulting in failing to obtain accurate temperature rise curve data. Such a situation is serious because it compromises the reliability of the test apparatus.

Next, in the case of the test apparatus described in Japanese Patent Publication No. 07-018870, the four temperature sensors 59 to 62 are inserted up to the desired positions on the thickness center plane of the sample rubber 64 after the vulcanization is started and the flowing of the sample rubber 64 in the cavity 63 comes to an end, and thus sample rubber 64 substantially equivalent to the total volume of the four temperature sensors 59 to 62 flows outside the mold via the vent holes 70 to 73, as a new surplus. This is not merely a matter of a surplus of the sample rubber 64 flowing outside the mold, but also means that the heat distribution of the sample rubber 64 with which the cavity 63 is filled is forcibly disturbed by the insertion of the temperature sensors 59 to 62. Even if the temperature sensors 59 to 62 measure temperatures in a chronological manner starting with the disturbed heat distribution state, accurate temperature rise curve data will not be obtained. Therefore, this situation also becomes a cause of compromising the reliability of the test apparatus.

Furthermore, there is also a problem with the above-described conventional, relevant apparatuses as illustrated in FIG. 12A to FIG. 13 in that the blowing limit observation region of the sample rubber (rubber specimen) overlaps with the putting disposition region(s) of the temperature sensor(s). Description will be made about this problem. First, of the sites in the vulcanized rubber specimen, sites at which the observation of a blowing limit is intended to lie in a cross-sectional region consisting of thickness center portions (at or in the vicinity of the thickness center) in which insufficient vulcanization due to heat transfer delay is prone to occur, that is, in the thickness center plane as described above. Here, with the intention to eliminate the influence of the heat sources in the lateral direction (an imbalance in heat distribution in the lateral direction) as much as possible, sites at the width center on the thickness center plane (these sites will also refer to as thickness center points) can be considered to be optimal sites in terms of observing a blowing limit. Next, while the thermal diffusion constant χ is calculated from the temperature rise curve of Expression (1), the temperature rise curve of Expression (1) assumes temperature rise plotting on the thickness center plane using a temperature sensor, as described above. Also in this case, it is obvious that measuring the temperatures at the sites at the width center on the thickness center plane (thickness center points) is preferable in terms of eliminating the influence of the heat sources in the lateral direction and obtaining an accurate temperature rise rate/temperature rise curve.

Under such circumstances, in conventional pieces of related art, a temperature sensor is put in a blowing limit observation region in sample rubber (a rubber specimen) in order to meet both demands. As a result, when the rubber specimen is horizontally cut along a thickness center plane after the temperature sensor is removed out from vulcanized rubber specimen, a trace of the temperature sensor interferes with a clear exposure of the thickness center plane. This also poses a problem in that accurate blowing limit observation may be obstructed.

Furthermore, the above-described conventional, relevant apparatuses each include a plurality of hot junctions, and thus a poor operations efficiency and a complexity of the device configuration are pointed out. Meanwhile, it is known that the coefficient of variation of thermal diffusion constants χ of sample rubber calculated based on temperature rise curves obtained from the plurality of hot junctions (the ratio of a standard deviation to an average value) is about 2.3% (Japanese Patent No. 5154185). This means that simultaneous multiple-point plotting using a plurality of hot junctions need not be performed, and one-point measurement using a single hot junction can offer temperature rise curve data having an accuracy as good as that of the simultaneous multiple-point plotting.

The present invention is made in view of the previously described circumstances and has a first objective to provide a vulcanizing mold for identifying a blowing-limit vulcanization degree that is capable of protecting a temperature sensor from deformation and damage, to provide a test apparatus including the vulcanizing mold, and a test method.

In addition, the present invention has a second objective to provide a vulcanizing mold for identifying a blowing-limit vulcanization degree that is capable of avoiding an overlap between the blowing limit observation region of sample rubber (a rubber specimen) and the putting disposition region of a temperature sensor, reliably, and to provide a test apparatus including the vulcanizing mold, and a test method.

To solve the problems described above, a first configuration of the present invention relates to a vulcanizing mold that includes an upper mold and a lower mold that pair off vertically. At least the lower mold is provided with a cavity in which unvulcanized sample rubber is charged, heated, and subjected to press vulcanization, so as to be formed into a rubber specimen for blowing limit observation continuously changing in vulcanization degree in a longitudinal direction. The cavity is provided with a first cavity that changes in depth from one end side to other end side in the longitudinal direction, and is for producing the rubber specimen, and additionally provided with a second cavity that connectedly extends from the first cavity and is a space in which a temperature sensor is disposed to plot a temperature rise curve of the sample rubber during the vulcanization. In a predetermined wall portion of the second cavity, temperature sensor insertion opening is provided that allows the temperature sensor to be disposed at a predetermined temperature-sensing site in the second cavity from the outside, in an insertable and removable manner.

A second configuration of the present invention relates to a test apparatus that includes the vulcanizing mold for identifying a blowing-limit vulcanization degree constituted by the first configuration of the present invention, wherein the rubber specimen for blowing limit observation is obtained from the first cavity of the vulcanizing mold, the rubber specimen continuously changing in degree of blowing, associated with a vulcanization degree, in a longitudinal direction, and temperature rise curve data on the sample rubber during the vulcanization is acquired from the second cavity. The second configuration includes a pressurization mechanism that causes the upper mold to descend and tightly fit with the lower mold, and heats unvulcanized sample rubber fluidized and charged into the first cavity and the second cavity to perform press vulcanization, and a temperature sensor that is disposed at a predetermined temperature-sensing site in the second cavity via the temperature sensor insertion opening in an insertable and removable manner and configured to plot a temperature rise curve of the sample rubber during the vulcanization.

A third configuration of the present invention is a test method for identifying a blowing-limit vulcanization degree using the second configuration of the present invention.

According to the configurations of the present invention, in at least the lower mold, the second cavity that functions as a temperature-sensing-purpose space is provided independently of the first cavity that functions as a specimen forming space. Therefore, it is possible to protect the temperature sensor from deformation and damage, which in turn allows the prolongation of the longevity of the temperature sensor. The reason for this is that, when the sample rubber is put, the sample rubber, including sample rubber to be charged into the second cavity, may be put into the first cavity, and in clamping, the sample rubber to be charged into the second cavity flows into the second cavity, when a strong viscoelasticity hydrodynamic force of the sample rubber acts only in the shaft direction of the temperature sensor (coincident with of the flowing direction of the sample rubber), and as a result, the temperature sensor does not undergo the action of the viscoelasticity hydrodynamic force not very strongly as a whole. In addition, automatizing the insertion and removal of the temperature sensor to the second cavity prevents human-caused damage to the temperature sensor due to carelessness or unskillfulness of an operator, and in addition achieves the improvement of workability.

In addition, since the temperature-sensing-purpose space is provided independently of the specimen forming space as described above, it is possible to avoid an overlap between the blowing limit observation region of sample rubber (a rubber specimen) and the putting disposition region of a temperature sensor, reliably.

For this reason, the heat distribution of the sample rubber is not disturbed by putting the temperature sensor, and thus it is possible to obtain a temperature rise rate/temperature rise curve with few errors. In addition, a clear cutting plane can be obtained from the vulcanized rubber specimen along a thickness center plane with no trace of the temperature sensor, and thus it is possible to perform the blowing limit observation accurately. Furthermore, the setting of the proper temperature-sensing site in the temperature-sensing-purpose space can be determined in a temperature-sensor-based manner, without the influence of the blowing limit observation region, and thus it is possible to obtain a more accurate temperature rise rate/temperature rise curve.

Therefore, according to the configurations of the present invention, it is possible to allow the temperature sensor to perform measurement at a proper temperature-sensing site, as well as to allow blowing limit observation to be performed on a clear cutting plane. Thus, it is possible to plot a sample rubber temperature rise rate/temperature rise curve faithfully, resulting in an increasing reliability and reproducibility of test results, which in turn allows accuracy in identifying the blow point of sample rubber to be further increased.

### BRIEF DESCRIPTION OF THE DRAWINGS

FIG. 1 is a diagram of a test apparatus for identifying a blow point being an embodiment of the present invention, illustrating a schematic configuration of the test apparatus, in which a lower mold moving forward to cause a temperature sensor to be inserted into the lower mold;

FIG. 2 is a diagram of the test apparatus for identifying a blow point, illustrating a schematic configuration of the test apparatus with the lower mold moving backward to cause the temperature sensor to be removed out from the lower mold;

FIGS. 3A and 3B each are a schematic configuration of the lower mold, where FIG. 3A is a plan view, and FIG. 3B is a front view;

FIGS. 4A and 4B each are a side view illustrating the configuration of the lower mold, where FIG. 4A is a diagram of an internal configuration illustrating a state in which a temperature sensor is inserted into the lower mold, with broken lines, and FIG. 4B is a diagram of an internal configuration illustrating a state in which the temperature sensor is removed out from the lower mold, with broken lines;

FIGS. 5A to 5C each are an illustrative diagram for illustrating the operation of the embodiment;

FIG. 6 is a schematic diagram illustrating the distribution state of bubbles generated in internal sections orthogonal to the longitudinal direction of a rubber specimen;

FIG. 7 is a graph illustrating a temperature rise curve of sample rubber acquired from the temperature sensor in a second cavity (temperature-sensing-purpose space);

FIG. 8 is a graph illustrating a time dependency of a temperature rise unsaturation degree α(t) in logarithm obtained by performing data processing on the temperature rise curve;

FIG. 9 is a graph obtained by normalizing the time dependency of the temperature rise unsaturation degree α(t) in logarithm illustrated in FIG. 8;

FIG. 10 is an analysis diagram used for identifying a blow point based on a vulcanization degree curve obtained using an oscillation vulcanization degree testing machine;

FIG. 11 is an illustrative diagram for illustrating how to analyze the vulcanization degree curve;

FIGS. 12A to 12C each are an illustrative diagram for illustrating a conventional, relevant apparatus; and

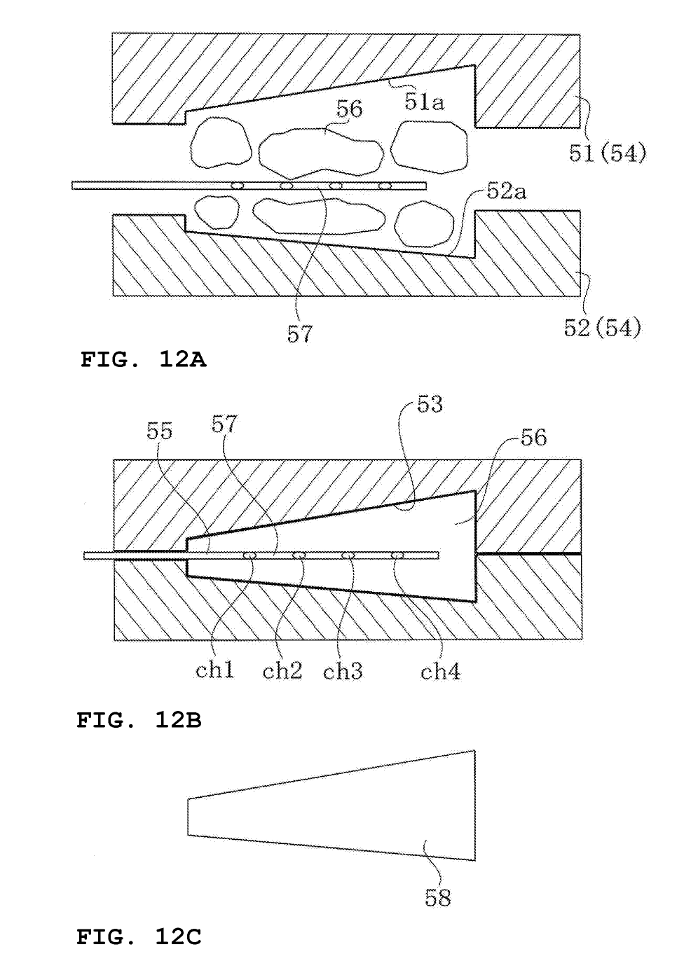

FIG. 13 is an illustrative diagram for illustrating another conventional, relevant apparatus.

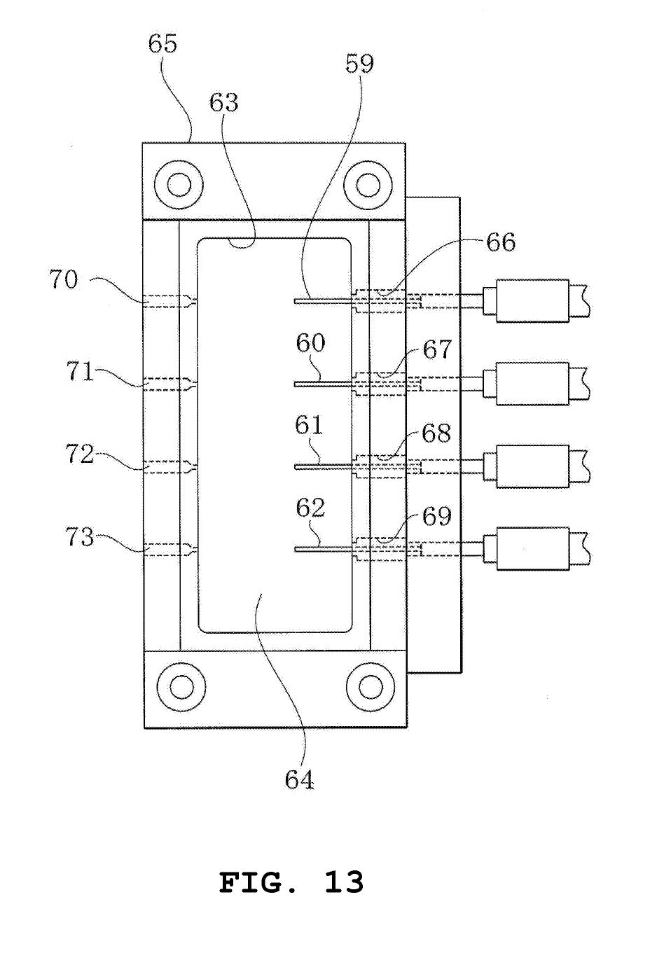

### DETAILED DESCRIPTION

An upper mold and a lower mold are clamped to form a first cavity to be a specimen forming space in such a manner that the first cavity gradually increases in depth from one end side to the other end side in a longitudinal direction, and similarly to form a second cavity to be a temperature-sensing-purpose space in such a manner that the second cavity is connected to the other end of the first cavity, and the second cavity is set to have a predetermined uniform depth shallower than the deepest portion of the first cavity and deeper than the shallowest portion of the first cavity, whereby the present invention is implemented.

In addition, a temperature-sensing site in the second cavity is set at or in the vicinity of the center part of the second cavity in a depth direction, and when the temperature sensor is put and disposed in the second cavity via a temperature sensor insertion opening, the leading end portion (a hot junction) of the temperature sensor is accurately positioned at the temperature-sensing site, whereby the present invention is implemented.

In addition, in order to put and dispose the temperature sensor at the temperature-sensing site in the second cavity via the temperature sensor insertion opening in an insertable and removable manner, the lower mold is configured to be movable in a horizontal direction relative to the temperature sensor by a predetermined drive mechanism, whereby the present invention is implemented.

### Embodiment 1

Hereinafter, an embodiment of the present invention will be described with reference to the accompanying drawings.

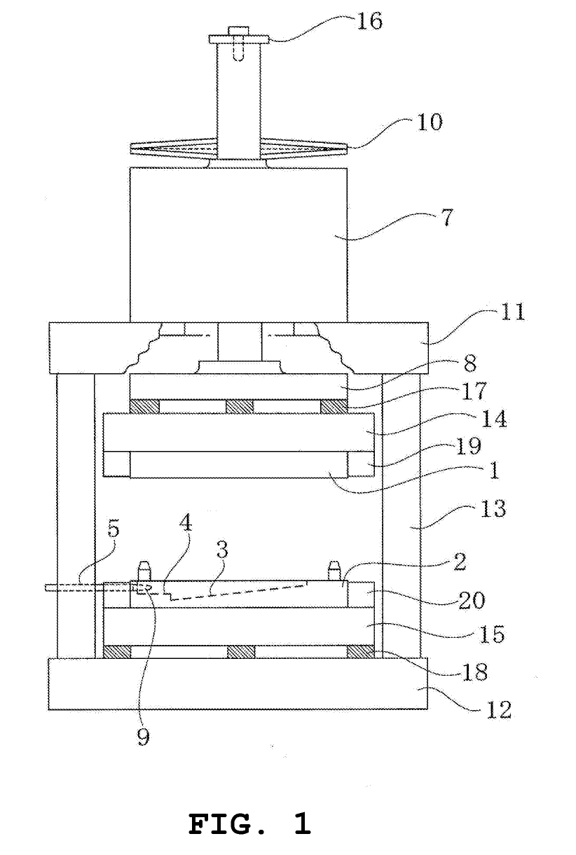

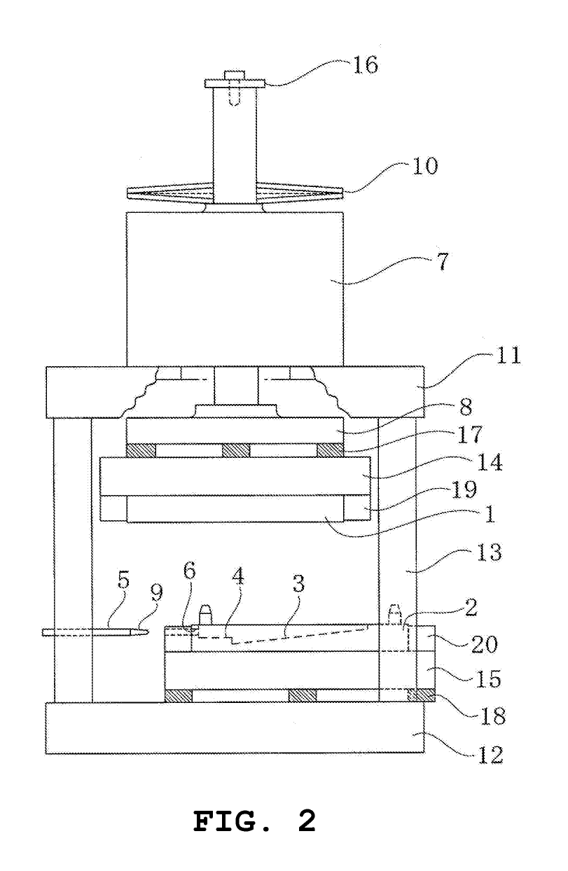

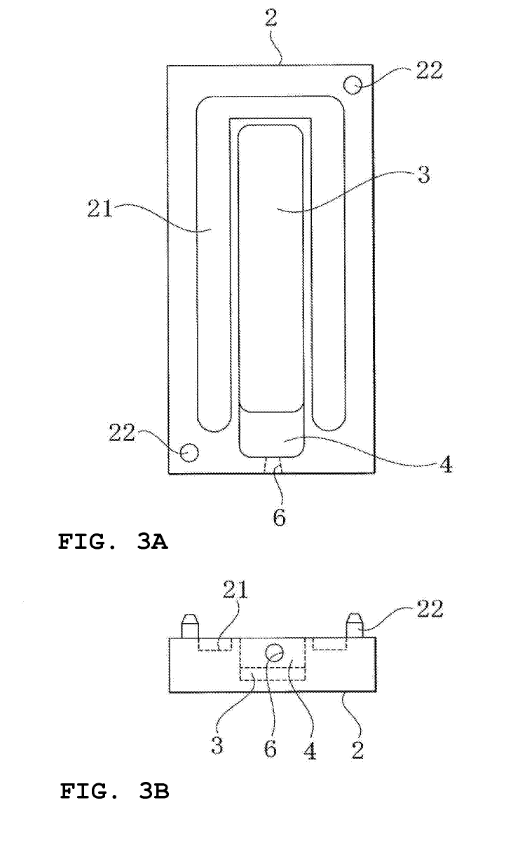

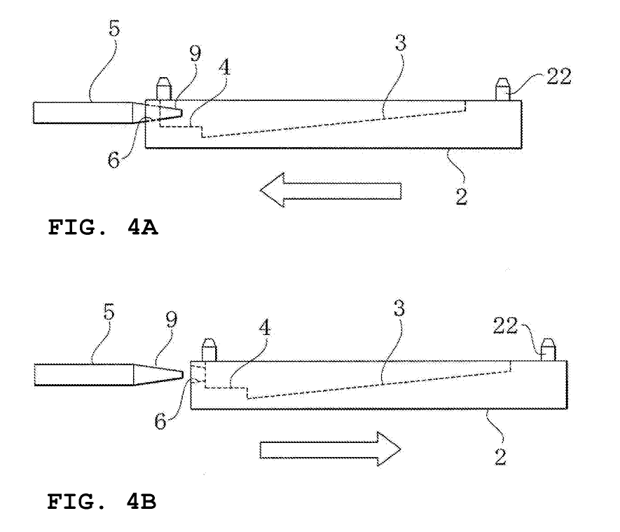

FIG. 1 is a diagram of a test apparatus for identifying a blow point being an embodiment of the present invention, illustrating the schematic configuration of the test apparatus, in which the lower mold moving forward to cause the temperature sensor to be inserted into the lower mold, and FIG. 2 is a diagram of the test apparatus for identifying a blow point, illustrating a schematic configuration of the test apparatus with the lower mold moving backward to cause the temperature sensor to be removed out from the lower mold. FIGS. 3A and 3B each are a schematic configuration of the lower mold, where FIG. 3A is a plan view, and FIG. 3B is a front view, and FIGS. 4A and 4B each are a side view illustrating the configuration of the lower mold, where FIG. 4A is a diagram of an internal configuration illustrating a state in which the temperature sensor is inserted into the lower mold, with broken lines, and FIG. 4B is a diagram of an internal configuration illustrating a state in which the temperature sensor is removed out from the lower mold, with broken lines;

First, the general configuration of the main part of the apparatus in the present embodiment will be described.

The test apparatus in the present embodiment relates to an apparatus that is configured to obtain a vulcanized rubber specimen for blowing limit observation and to acquire temperature rise curve data on sample rubber during heating and press vulcanization. The schematic configuration of the main part of the apparatus includes a vulcanizing mold, a pressurization mechanism, a temperature sensor fixed to the apparatus in an immovable state, a decompression retention mechanism, and a frame structure supporting, fixing, and housing these components.

Next, referring to FIG. 1 to FIG. 4B, each component of the apparatus in the present embodiment will be described.

The main part of the vulcanizing mold is constituted by an upper mold 1 and a lower mold 2, which pair off vertically. The upper mold 1 includes a tightly-fit surface that faces the lower mold 2 and is formed into a planar shape. The lower mold 2 includes a first cavity 3 and a second cavity 4 on a tightly-fit surface thereof that faces the upper mold 1. The first cavity 3 has a rectangular shape in plan view and has a wedge shape that gradually increases in depth as it extends from one end side in a longitudinal direction thereof (the right of the drawings) toward the other end side (the left of the drawings). The second cavity 4 connectedly extends from the other end of the first cavity 3 with no partition wall and is uniform in depth. The upper mold 1 is configured so as to ascend and descend under the operation of the pressurization mechanism that will be described later. In addition, the lower mold 2 is configured to be driven and controlled in a horizontally movable manner in a direction toward a temperature sensor 5 or a direction away from the temperature sensor 5 by a lower mold drive mechanism (to be described later), so that the movement of the lower mold 2 causes the temperature sensor 5 to be inserted into or removed from the lower mold 2, the temperature sensor 5 being fixed to the body of the apparatus in an immovable state.

Here, when the upper mold 1 and the lower mold 2 are clamped under the operation of the pressurization mechanism, the first cavity 3 serves as a specimen forming space that forms unvulcanized sample rubber cast and charged therein into an approximate wedge shape. In the space, fluidized and charged sample rubber is heated and subjected to the press vulcanization, thereby formed into a rubber specimen for blowing limit observation, the vulcanization degree of which continuously varies in the longitudinal direction.

Next, as illustrated in detail in FIG. 4A and FIG. 4B, in spatial terms, the second cavity 4 connectedly extends from the first cavity 3 in the longitudinal direction of the first cavity 3 with a step interposed therebetween. However, after the clamping, the second cavity 4 serves as a temperature-sensing-purpose space that is separated from and independent of the first cavity 3 (specimen forming space), and sample rubber to be vulcanized in the space becomes a subject of temperature rise curve plotting using the temperature sensor 5. As illustrated in the drawings, the depth of the second cavity 4 is set to be shallower than the deepest portion and deeper than the shallowest portion, of the first cavity 3. This is because a blowing limit site lies at the midpoint between the deepest portion and the shallowest portion of the first cavity 3, and thus the second cavity 4 is preferably set to a depth equivalent to the midpoint in depth of the first cavity, in terms of increasing the reliability of test results. In the present embodiment, the shallowest portion of the first cavity 3 is set at 6 mm, the deepest portion of the first cavity 3 is set at 22 mm, the depth of the second cavity 4 is set at 14 mm, the step is set at 8 mm, and the overall length of the first cavity 3 and the second cavity 4 is set at 160 mm. These dimensions are merely an example and can be changed as appropriate in accordance with the scale of the apparatus, the scale of the measurement, and other factors.

Now, as illustrated in FIG. 3A to FIG. 4B, of the wall portions of the second cavity 4, a wall portion corresponding to the surface of the one end of the lower mold 2 (shown in the left of the FIG. 4A and FIG. 4B) is provided with a temperature sensor insertion opening 6 having a function with which to allow the leading end portion of the temperature sensor 5 to be disposed from the outside at a desired depth at the width center on the depth center plane of the second cavity 4 (a predetermined proper temperature-sensing site, simply stated, a proper temperature-sensing point) in an insertable and removable manner. To implement this function, the whole or part of the temperature sensor insertion opening 6 is tapered, so that the temperature sensor insertion opening 6 has a wide opening on its external side and has a narrow opening on its side close to the second cavity 4.

The pressurization mechanism includes, as illustrated in FIG. 1 and FIG. 2, a double-shaft air cylinder 7 and an ascending-descending base 8, and is configured to descend the upper mold 1 to tightly fit with the lower mold 2 and heat unvulcanized sample rubber fluidized and charged into the first cavity 3 and the second cavity 4 to perform press vulcanization. The pressurization operation of the double-shaft air cylinder 7 is controlled by a first timer (not illustrated) for setting a press vulcanization time period.

In the present embodiment, while the temperature sensor 5 is fixed to the body of the apparatus and brought into an immovable state on its temperature-sensor side, the lower mold 2 moves, as illustrated in FIG. 4A and FIG. 4B, forward and backward in the horizontal direction under drive control by the lower mold drive mechanism (not illustration), so that the temperature sensor 5 is disposed relatively to the proper temperature-sensing site in the second cavity 4 in an insertable and removable manner through the temperature sensor insertion opening 6, and plots the temperature rise curve of the sample rubber during the vulcanization. In the present embodiment, the plotting of the temperature rise curve is performed using only the single temperature sensor 5. This is because it has been confirmed that, as described above, not by simultaneous plotting using a plurality of hot junctions, plotting at only one point using a single hot junction allows for obtaining temperature rise curve data of a measurement reliability as high as in the case of simultaneous multiple-point plotting.

The temperature sensor 5 is made up of a rod-shaped thermocouple temperature sensor, and in the present embodiment, made up of a thermocouple wire housed in and protected by a metal tubule on a sensor holder (not illustrated) side, having an outer diameter of about 8 mm, and a resin tubule on a temperature sensor insertion opening 6 side, having an outer diameter of about 6 mm. The resin tubule includes a tapered leading end portion 9 that has the same cross-sectional shape and the same dimensions as those of the whole or part of the temperature sensor insertion opening 6. The tip of the leading end portion 9 is opened in the form of a small hole having a diameter of about 1 mm, and a hot junction of a thermocouple is bared from the small hole, so as to be brought into thermal contact with sample rubber.

As seen from the above, the leading end portion 9 of the temperature sensor 5 and the temperature sensor insertion opening 6 are wholly or partially formed into tapered shapes having the same cross-sectional shape and the same dimensions, whereby the leading end portion 9 of the temperature sensor 5 is closely fit with the temperature sensor insertion opening 6, so as to function as a sealing plug for preventing the sample rubber charged into the second cavity 4 from flowing to the outside (FIG. 4A). Meanwhile, the temperature sensor insertion opening 6 is configured to, at the time of the forward movement of the lower mold 2, function as a tapered positioning stopper that engages with and stops the leading end portion 9 of the temperature sensor 5 entering the second cavity 4, at the proper temperature-sensing site (FIG. 4A). In place of the tapered positioning stopper, dedicated positioning means or a dedicated stopper may be provided separately.

In the state of being removed out from the second cavity 4 (FIG. 4B), the temperature sensor 5 is quickly cooled down to, for example, room temperature by the operation of an auto cooling mechanism (not illustrated). The auto cooling mechanism is made up of a blower and the like, and provided integrally with or separately from the body of the apparatus. As necessary, a manual cooling mechanism may be used in place of the auto cooling mechanism.

The above-described decompression retention mechanism includes, as illustrated in FIG. 1 and FIG. 2, the double-shaft air cylinder 7 and the ascending-descending base 8, and a toroidal leaf spring 10, and is configured to, after the sample rubber is subjected to the press vulcanization for a predetermined time period, release the pressure of pressurization mechanism to atmospheric pressure and then retain a decompressed state in which the upper mold 1 is slightly lifted up by reaction force accumulated in the leaf spring 10 by the pressurization. The decompression retention operation of the double-shaft air cylinder 7 is controlled by a second timer for setting a decompression retention time period. The frame structure is made up of an upper base plate 11, a lower base plate 12, and poles 13, and supports, places, fixes, and houses the main part of the apparatus.

Next, referring to FIG. 1 to FIG. 4B, each component of the apparatus will be described in more detail.

An upper soaking plate 14 is configured to maintain the upper mold 1 on its lower side in a soaked state by supporting the upper mold 1 in a thermal contact state. Similarly, the lower soaking plate 15 is configured to maintain the lower mold 2 on its upper side in a soaked state by supporting the lower mold 2 in a thermal contact state.

Specifically, the upper soaking plate 14 is heated uniformly by an electrical heater embedded in its inner portion and further regulated at a certain temperature by a temperature sensor and a temperature regulator, so that the upper mold 1 disposed abutting the lower surface of the upper soaking plate 14 is caused to act as a heat source in the soaked state for sample rubber during vulcanization. Similarly, the lower soaking plate 15 is also heated uniformly by an electrical heater embedded in its inner portion and further regulated at a certain temperature by a temperature sensor and a temperature regulator, so that the lower mold 2 disposed abutting the upper surface of the lower soaking plate 15 is caused to act as a heat source in the soaked state for the sample rubber during the vulcanization. Here, it is preferable, of course, that the upper soaking plate 14, the lower soaking plate 15, the upper mold 1, and the lower mold 2 are made of high-heat-conductivity materials.

The double-shaft air cylinder 7 includes shafts that penetrate vertically, and vertically ascends and descends the ascending-descending base 8 that is connected to the lower ends of the shafts, with the ascent and descent of the shafts. The ascending-descending base 8 moves the upper mold 1 vertically via the upper soaking plate 14 disposed on the lower portion thereof with the ascent and descent of the shafts of the double-shaft air cylinder 7, so as to cause the upper mold 1 and the lower mold 2 to open, close, tightly fit with each other, and detach from each other.

Next, in the above-described decompression retention mechanism, the toroidal leaf spring 10 is fit into the upper shaft of the double-shaft air cylinder 7, and during clamping, the leaf spring 10 is compressed at a tightly-fit position of the upper mold 1 and the lower mold 2 by a cover plate 16 fixed to the upper end of the shaft, whereby upward reaction forces are generated in the shafts of the double-shaft air cylinder 7. In the present embodiment, this upward reaction force is set so as to, when the internal pressure of the double-shaft air cylinder 7 is released, lift up the gross weight of an object that ascends and descends with the double-shaft air cylinder 7, and to form a gap of about several millimeters between the upper mold 1 and the lower mold 2. By this upward reaction force, the upper mold 1 is slightly lifted up, so that the decompressed state is retained.

An upper thermal insulation spacer 17 is made of a hard thermal insulator, suppressing heat leakage from the upper soaking plate 14. A lower thermal insulation spacer 18 is also made of a hard thermal insulator, suppressing heat leakage from lower soaking plate 15. An upper soaking guard 19 is made up of light-alloy-square-bar members that surround the upper mold 1 in parallel crosses, preventing heat dissipation from the side surfaces of the upper mold 1. A lower soaking guard 20 is made up of light-alloy-square-bar members that surround the lower mold 2 in parallel crosses, preventing heat dissipation from the side surfaces of the lower mold 2.

In addition, the lower mold drive mechanism includes guard rails (not illustrated) used for driving the lower mold 2 so that the lower mold 2 can travel relative to the temperature sensor 5 fixed to the body of the apparatus, and a controller (not illustrated) that controls the forward movement and backward movement of the lower mold 2.

In the present embodiment, as illustrated in FIG. 4A, when the lower mold 2 moves forward toward the temperature sensor 5 under the drive control by the lower mold drive mechanism, the temperature sensor 5 is automatically inserted into the second cavity 4 through the temperature sensor insertion opening 6. Then, when the temperature sensor 5 reaches the proper temperature-sensing site in the second cavity 4, the positioning stopper function of the temperature sensor insertion opening 6 works to disable further forward movement of the lower mold 2, and thus the lower mold 2 stops the forward movement at that time point. As a result, the temperature sensor 5 stays at the proper temperature-sensing site in the second cavity 4, that is, is automatically installed in the second cavity 4 and automatically disposed at a proper position. Meanwhile, as illustrated in FIG. 4B, when the lower mold 2 moves backward relative to the temperature sensor 5 under the control by the lower mold drive mechanism, the temperature sensor 5 is automatically removed out from the second cavity 4 via the temperature sensor insertion opening 6.

On the tightly-fit surface of the lower mold 2 (facing the upper mold 1), as illustrated in FIGS. 3A and 3B, a U-shaped flash groove 21 is provided surrounding the first and second cavities 3 and 4 on three sides (FIG. 3A) or four sides, the flash groove 21 storing a surplus of the sample rubber flowed out to the outside from the first and second cavities 3 and 4 when the press vulcanization is started. Furthermore, on the peripheral edge portion of the lower mold 2, alignment pins 22 are provided as aligning means for engaging the upper mold 1 and the lower mold 2 accurately in clamping, the alignment pins 22 being to be fitted into alignment pin holes (not illustrated) provided on the peripheral edge portion of the upper mold 1.

Next, referring to FIG. 1 to FIG. 5C, the operation of the test apparatus having the above configuration will be described.

First, the temperatures of the heat sources are set and kept at, for example, 170° C. Here, the temperatures of the heat sources refer to the temperatures of the upper mold 1 and the lower mold 2 heated by the upper soaking plate 14 and the lower soaking plate 15, respectively.

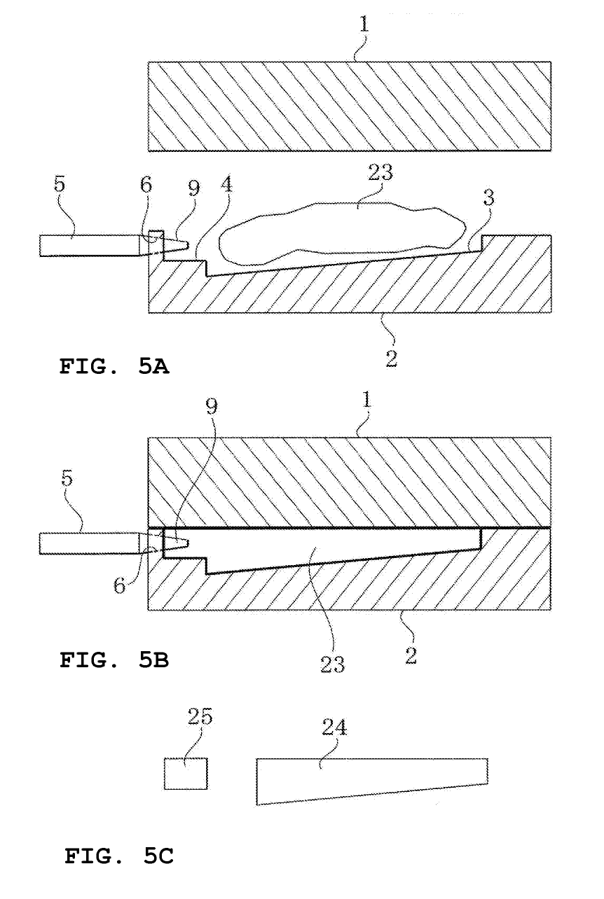

When the temperatures of the heat sources reach their stationary state, an operator puts unvulcanized sample rubber 23 made of, for example, an SBR-based compounded rubber containing carbon black 50PHR into the first cavity 3 of the lower mold 2 (FIG. 5A). The amount of putting the sample rubber is set to be slightly larger than the total sum of the volume of the first cavity 3 and the volume of the second cavity 4. However, the operator does not put the sample rubber 23 into the second cavity 4. Therefore, at this point, the second cavity 4 is a void, recessed space with no put sample rubber and with no temperature sensor inserted.

Thereafter, the lower mold 2 starts forward movement toward the apparatus-fixed temperature sensor 5 under the drive control by the lower mold drive mechanism. As the forward movement of the lower mold 2 progresses, the temperature sensor 5 is automatically inserted into the void second cavity 4 via the temperature sensor insertion opening 6. Then, when the temperature sensor 5 reaches the proper temperature-sensing site in the second cavity 4, the positioning stopper function of the temperature sensor insertion opening 6 works to disable further forward movement of the lower mold 2, and thus the lower mold 2 stops the forward moving at that time point (FIG. 1 and FIG. 4A). As a result, the hot junction at the leading end portion 9 of the temperature sensor 5 is accurately retained at the proper temperature-sensing site in the second cavity 4, that is, automatically installed in the second cavity 4, and automatically disposed at a predetermined proper position (FIG. 5A). Note that the temperature of the temperature sensor 5 is set at room temperature as an initial temperature.

Next, when the first timer for setting a press vulcanization time period starts, the pressurization mechanism (the double-shaft air cylinder 7 and the ascending-descending base 8) causes the upper mold 1 to descend, causes the alignment pins 22 and 22 to be fit into the alignment pin holes, thereby causes the lower mold 2 and the upper mold 1 to tightly fit on each other to be clamped. When the upper mold 1 and the lower mold 2 are clamped, the first cavity 3 of the lower mold 2 joins the plane of the upper mold 1 to be a specimen forming space 3 that has a rectangular shape in plan view and has a wedge shape that gradually increases in depth from one end side in the longitudinal direction (the right of the drawings) to the other end side (the left of the drawings), and the second cavity 4 of the lower mold 2 joins the plane of the upper mold 1 to be a temperature-sensing-purpose space 4 that connectedly extends from to the other end of the specimen forming space without partition wall and has a uniform depth (FIG. 5B). At this point, the specimen forming space is filled with the unvulcanized sample rubber 23 put into the first cavity 3 of the lower mold 2 as the clamping proceeds, due to the fluidity of the unvulcanized rubber, and a surplus of the sample rubber 23 flows into the temperature-sensing-purpose space in which the hot junction of the temperature sensor 5 is already disposed properly, and the temperature-sensing-purpose space is also fully charged with the surplus of the sample rubber 23, and a further surplus of the sample rubber 23 is discharged to the U-shaped flash groove 21 surrounding the outside of the first and second cavities 3 and 4 (FIGS. 3A and 3B).

By heat conduction from the inner walls of the upper mold 1 and the lower mold 2 that begins at the instant of clamping, the unvulcanized sample rubber 23 in the specimen forming space 3 and the temperature-sensing-purpose space 4 quickly rises in temperature from room temperature, in accordance with thicknesses. In the specimen forming space 3, the charged sample rubber 23 is heated and subjected to press vulcanization to be formed into a rubber specimen 24 for blowing limit observation that continuously changes in vulcanization degree in the longitudinal direction. In the temperature-sensing-purpose space 4, by the temperature sensor 5 the hot junction of which is retained at the proper temperature-sensing site, the temperature of the sample rubber 23 around the hot junction charged in the space is traced from the room temperature, and is temperature rise curve is plotted.

In the present embodiment, when a press vulcanization time period expires that is set in advance at, for example, 240 seconds, an ending signal from the first timer causes the internal pressure of the double-shaft air cylinder 7 to be released to atmospheric pressure. As a result, the reaction force of the leaf spring 10 slightly lifts up the upper mold 1, and a gap occurs in the tightly-fit interface between the upper mold 1 and the lower mold 2, when the press vulcanization ends. At the same time, the second timer for setting a decompression retention time period starts its operation.

When the gap occurs in the tightly-fit surface between the upper mold 1 and the lower mold 2 by the reaction force of the leaf spring 10, the internal pressure of the sample rubber that is retained at a high pressure thus far declines to atmospheric pressure in an instant, and various low-boiling components (e.g., moisture) enclosed in the rubber specimen 24 by a high temperature and pressure attempt to vaporize all at once. At this point, in an “under-vulcanized” portion where the vulcanization does not progress to an elastic modulus level that is sufficient to suppress the occurrence of bubbles, fine bubbles are generated in the continuous solid phase of the rubber in accordance with a degree of “under-vulcanization” state. This is the mechanism of decompressed blowing.

Bubbles generated by the decompressed blowing do not swell in an instant, and the swell of the bubbles involves a slight time delay due to a viscoelasticity unique to rubber. For this reason, a waiting-swell time is needed to some extent until bubbles enlarge to sizes recognizable in cross section observation. Here, although it is generally known, the swelling velocity in the decompressed blowing depends on the gas pressure of bubbles, and the gas pressure increases with an increase in temperature. In contrast, the breaking strength of the rubber, being resistance force against to the swell of bubbles, declines with an increase in temperature. Thus, in the present embodiment, the process of the decompressed blowing is performed in such a manner that subjects the rubber specimen 24 to non-pressure retention at the same temperature as the temperature in the press vulcanization, for a time period as short as about 30 seconds. The reason for this is that subjecting the rubber specimen 24 to the non-pressure retention with the temperature kept at that in the press vulcanization allows the bubbles to grow to recognizable sizes quickly and stably, and as a result, the cross section observation of a blowing limit at the thickness center point of the rubber specimen 24 can be performed accurately and easily.

When the decompression retention time period set in advance expires, an ending signal from the second timer switches the operation of the double-shaft air cylinder 7 and the lower mold drive mechanism, and the upper mold 1 is lifted up via the ascending-descending base 8 (FIG. 1), and the lower mold 2 moves backward relative to the temperature sensor 5 (FIG. 2 and FIG. 4B). Accordingly, the temperature sensor 5 is automatically removed out from the second cavity 4 via the temperature sensor insertion opening 6 (FIG. 2 and FIG. 4B).

Thereafter, the wedge-shaped rubber specimen 24 continuously changing in blowing state in the longitudinal direction can be taken out from the first cavity 3, and from the second cavity 4, a sample rubber piece 25 the temperature of which has been measured can be taken out. The rubber specimen 24 and the sample rubber piece 25 are taken out collectively, and thereafter cut off and separated (FIG. 5C).

The temperature sensor 5 removed out from the second cavity 4 is quickly cooled down to room temperature (the initial temperature) by the auto cooling mechanism to prepare for the next temperature rise plotting and brought into a standby state.

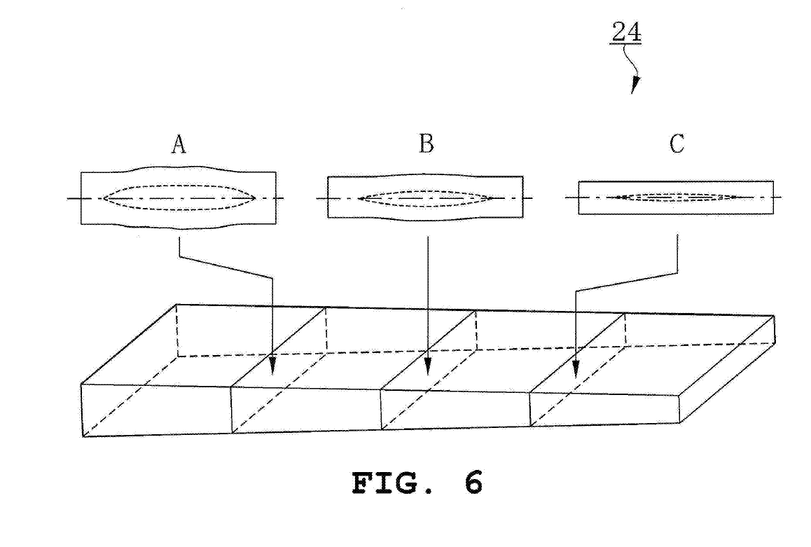

FIG. 6 is a schematic diagram illustrating the distribution state of bubbles generated in internal sections A, B, and C each orthogonal to the longitudinal direction of the vulcanized rubber specimen 24 taken out from the cavity of the vulcanizing mold.

As illustrated in FIG. 6, the rubber specimen 24 is formed into a wedge shape that has a rectangular shape in plan view and gradually decreases in wall thickness from one end side (the left of the drawing) to the other end side (the right of the drawing) in a longitudinal direction, an internal section closer to the left of the drawing shows a section of a site having a larger wall thickness, and an internal section closer to the right of the drawing shows a section of a site having smaller wall thickness. In FIG. 6, the internal section A shows a distribution state of bubbles that appear in, of the wedge-shaped rubber specimen 24, a section of a site having a larger wall thickness, and the internal section B shows a distribution state of bubbles that appear in a section of a site having an intermediate wall thickness, and the internal section C shows a distribution state of bubbles that appear in a section of a site having a small wall thickness.

According to the mechanism of the decompressed blowing, bubbles are generated in a site that delays in temperature rise in the rubber specimen 24, that is, “under-vulcanized” portion, and thus prone to be generated in sites far from the inner walls of the upper mold 1 and the lower mold 2, and hard to be generated in sites close to the inner walls. Here, the inner walls include the tightly-fit surface of the upper mold 1 that defines the specimen forming space 3 and the bottom surface of the first cavity 3, as well as side wall surfaces (i.e., side wall surfaces of the first cavity 3).

As a result, bubbles appearing in the internal sections orthogonal to the longitudinal direction of the rubber specimen 24 tends to distribute, as illustrated in FIG. 6, in an elliptical shape centering on a zone excluding both ends of the thickness center line of the rubber specimen 24. The vertical width of the ellipse narrows as a site close to the blowing limit site, as illustrated in the internal section C, and in the blowing limit site, bubbles are concentrated on the thickness center line of the rubber specimen 24. Therefore, to evaluate generated bubbles on a single cross section with efficiency, it is most preferable to select the thickness center plane of the rubber specimen 24 as a cutting plane.

Identifying Blowing Limit Site and Calculating Thickness

Thus, in the present embodiment, using a cutting machine, the vulcanized rubber specimen 24 is divided in the thickness direction into two pieces, the thickness center plane of the vulcanized rubber specimen 24 is exposed, and the exposed thickness center plane is captured by a camera. Then, the breaking point of the occurrence of confirmable fine bubbles, that is, a blowing limit site is identified from the cross section observation performed on a captured image of the thickness center plane, and a length from the reference position to the blowing limit site is measured.

Thereafter, based on the measured length from the reference position to the blowing limit site, and the thickness at the reference position, and the gradient of the rubber specimen, the thickness of the rubber specimen at the blowing limit site is calculated. As necessary, in place of the cross sectional image, an optical-automatic blowing recognition device may be used, or the cross section observation may be directly performed in a visual manner.

Calculation of Thermal Diffusion Constant χ

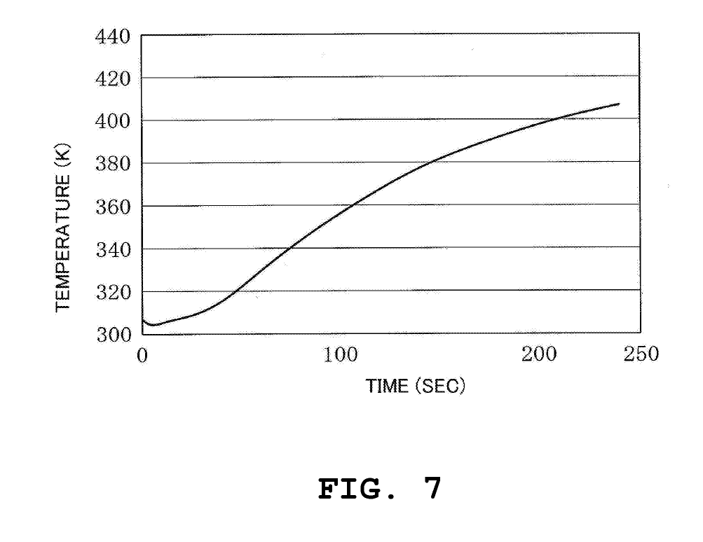

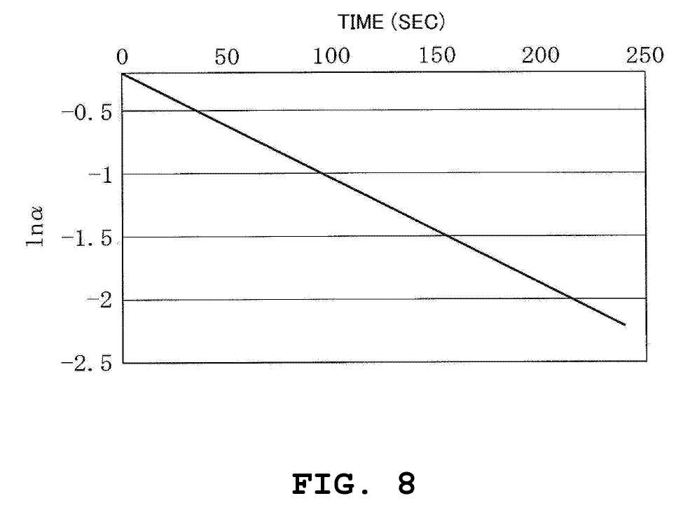

FIG. 7 is a graph illustrating a temperature rise curve of the sample rubber 23 plotted in the second cavity (the temperature-sensing-purpose space having the known thickness) 4 using the temperature sensor 5. By applying, to Expression (1), data on chronological temperature changes obtained from the plotted temperature rise curve of FIG. 7 to convert the temperature axis into a temperature rise unsaturation degree α(t) of the sample rubber 23 at a thickness center point in the second cavity (temperature-sensing-purpose space) 4, and the illustration of the time dependency of the natural logarithm ln α(t) yields a substantially linear graph corresponding to Expression (2) that is derived from theory of heat conduction, as illustrated in FIG. 8.

Thus, data on FIG. 8 is subjected to straight-line approximation by the method of least squares to calculate a gradient coefficient, and a heat transfer distance (h) from the heat sources to the hot junction and the gradient coefficient are substituted into Expression (3), which gives a calculation of 0.132 mm²/sec as the value of the thermal diffusion constant χ of the sample rubber 23 made of the SBR-based compounded rubber containing carbon black 50PHR, the current test object. In the present embodiment, since the hot junction of the temperature sensor 5 is disposed up to the thickness center point of the sample rubber charged into the second cavity (temperature-sensing-purpose space) 4, the heat transfer distance h from the heat sources to the hot junction is half the depth of the second cavity 4 (14 mm), that is, 7 mm.

In the present embodiment, 0.132 mm²/sec, the value of the thermal diffusion constant χ of the sample rubber 23 is calculated based on the temperature rise curve plotted at the single hot junction, as described above, and the calculation value falls within a range of the coefficient of variation 2.3% indicating the degree of variations in the thermal diffusion constants χ calculated based on the temperature rise curves plotted at the hot junctions in the case of applying the conventional simultaneous multiple-point plotting method. Therefore, this can be considered to show good reproducibility as a measured value of such a kind.

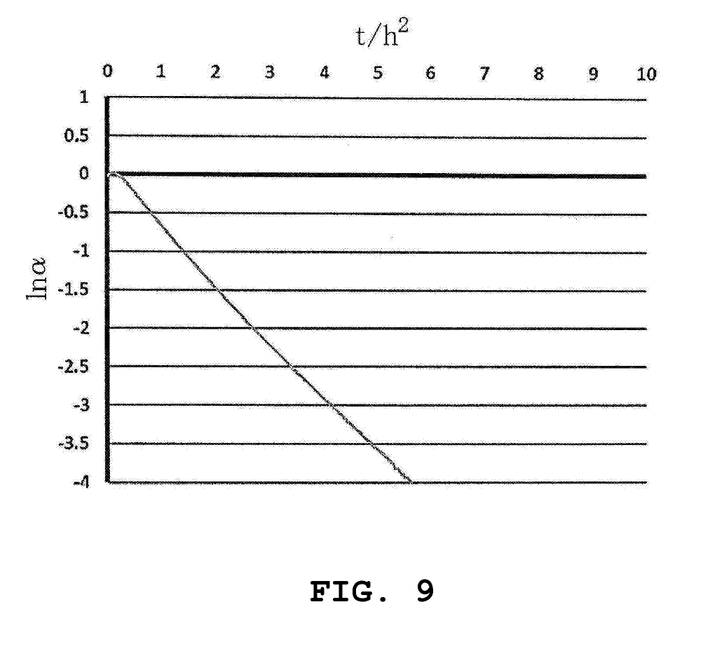

In FIG. 8, since the horizontal axis of the time dependency represents time t, the gradient coefficient differs according to the thickness h, but when the horizontal axis represents t/h², as illustrated in FIG. 9, the time dependency and the gradient coefficient of the logarithm of the temperature rise unsaturation degree α(t) can be generalized regardless of the thickness h. Therefore, organizing the data using FIG. 9 in which the horizontal axis is the t/h² axis is useful in measurement using a small piece sample, in the simulation of a normal tire, as well as in the study of vulcanization conditions in a producing step of a large tire including an aircraft tire.

Calculating Equivalent Vulcanization Time Period

The thermal diffusion constant χ of the sample rubber 23 and the thickness “2h” at the blowing limit site of the rubber specimen 24 (the breaking point of the occurrence of fine bubbles) calculated in such a manner are substituted into Expression (2) to calculate the logarithm ln α(t) of the temperature rise unsaturation degree α(t) of the sample rubber 23, the calculated ln α(t) is converted into α(t), and then based on Expression (1) that gives α(t), the temperature rise curve (calculated temperature rise curve) of the sample rubber 23 at the blowing limit site is calculated.

Next, based on the calculated temperature rise curve of the sample rubber 23 obtained from Expression (1) and the activation energy of the sample rubber, the definite integral of Expression (5) is performed to calculate the equivalent vulcanization time period (the reference temperature retention time period equivalent to the thermal history at the blowing limit site). In the present embodiment, as described above, since the vulcanization conditions of the sample rubber 23 is set at the reference temperature (the temperature of the heat sources) of 170° C. and the vulcanization time period of 240 seconds, the calculated temperature rise curve at the blowing limit site of the sample rubber 23, the definite integral of Expression (5) is performed in the range of [t₁=0, t₂=240 sec] to calculate the equivalent vulcanization time period at 170° C. The equivalent vulcanization time period calculated in such a manner is, for example, 144 seconds.

An actual value of the temperature rise curve T(t) is stored in a computer in the form of an isochronous digital sequence, and thus the definite integral of Expression (5) can be easily performed by an automatic computing process of the computer.

Identifying Blow Point (Blowing-Limit Vulcanization Degree)

In the present embodiment, the blow point is identified by applying the calculated equivalent vulcanization time period to a vulcanization degree curve that is plotted for the same sample rubber and at the same reference temperature.

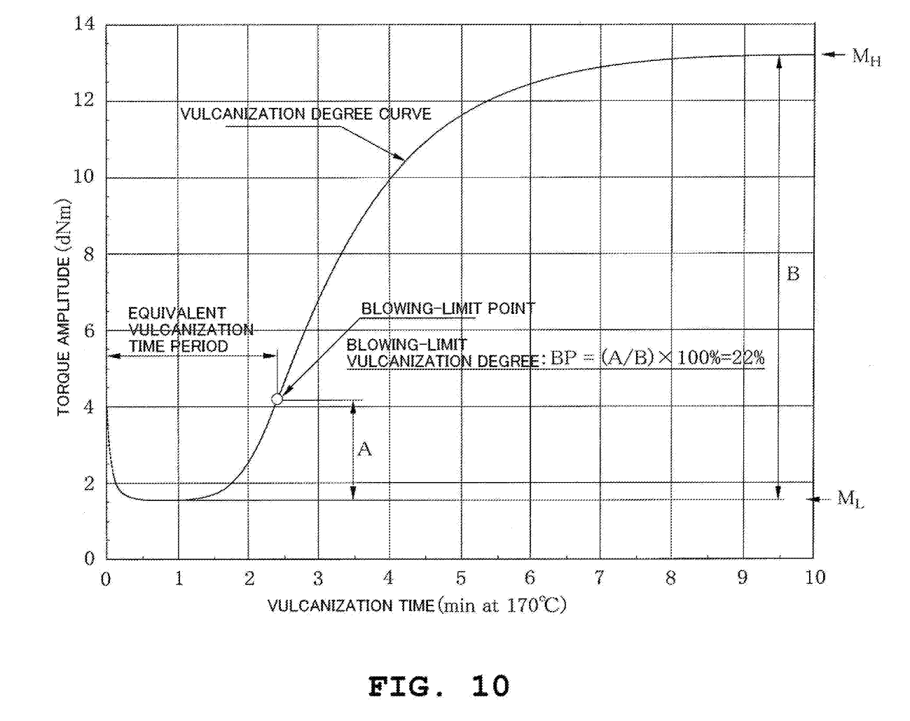

FIG. 10 is an analysis diagram illustrating the vulcanization degree curve of the sample rubber 23 at a reference temperature of 170° C. that is plotted separately using an oscillation vulcanization degree testing machine (Machine name: FDR).

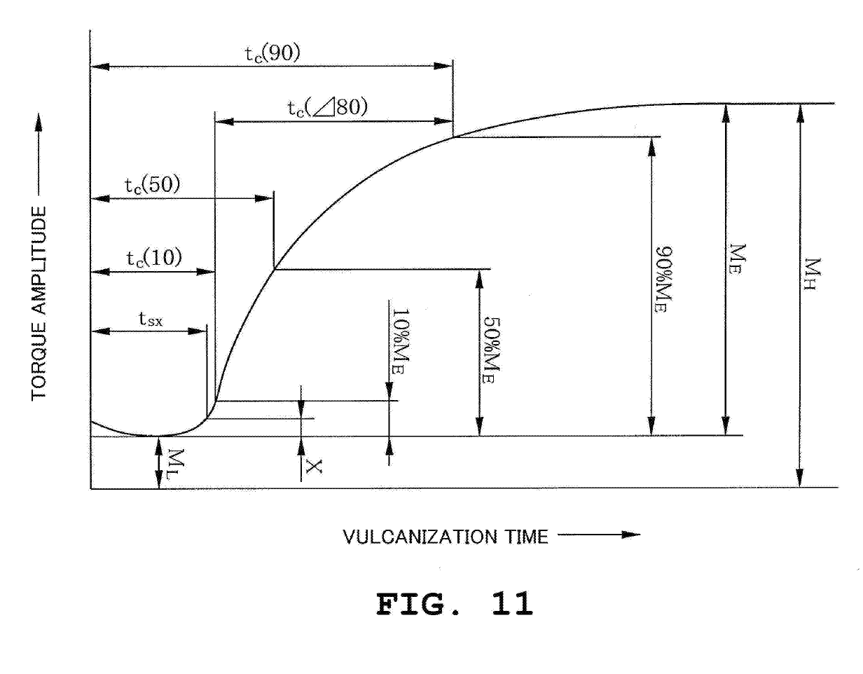

In the drawing, the mark ◯ on the vulcanization degree curve indicates a point corresponding to an equivalent vulcanization time period of 144 seconds, and by substituting a vertical axis value at this corresponding point, and values M_{L}, M_{H}, and M_{E} shown in FIG. 11 calculated by the method of JIS K 6300-2 are into Expression (6), a blow point (BP) is identified. In such a manner, in the present embodiment, a value of 22% is obtained as the blow point (BP) of the sample rubber 23.

As seen from the above, according to the configuration of the present embodiment, the second cavity (temperature-sensing-purpose space) is provided in the lower mold independently of the first cavity (specimen forming space), it is possible to protect the temperature sensor from deformation and damage. The reason for this is that, when the sample rubber is put, the sample rubber, including sample rubber to be charged into the second cavity, may be put into the first cavity, and in clamping, the sample rubber to be charged into the second cavity flows into the second cavity, when a strong viscoelasticity hydrodynamic force of the sample rubber acts only in the shaft direction of the temperature sensor (coincident with of the flowing direction of the sample rubber), and as a result, the temperature sensor does not undergo the action of the viscoelasticity hydrodynamic force not very strongly as a whole. In addition, automatizing the insertion and removal of the temperature sensor to the second cavity prevents human-caused damage to the temperature sensor due to carelessness or unskillfulness of an operator.

In addition, as described above, since the temperature-sensing-purpose space is provided independently of the specimen forming space as described above, it is possible to avoid an overlap between the blowing limit observation region of sample rubber (a rubber specimen) and the putting disposition region of a temperature sensor, reliably. Therefore, a clear cutting plane can be obtained from the vulcanized rubber specimen along a thickness center plane with no trace of the temperature sensor, and thus it is possible to perform the blowing limit observation accurately. Furthermore, the setting of the proper temperature-sensing site in the temperature-sensing-purpose space can be determined in a temperature-sensor-based manner, without the influence of the blowing limit observation region, and thus it is possible to obtain a more accurate temperature rise rate/temperature rise curve.

Therefore, it is possible to increase reliability and the reproducibility of the test results of this kind, which in turn allows accuracy in identifying the blow point of the sample rubber.

As described above, an embodiment of the present invention is described in detail with reference to the drawings, but the specific configuration is not limited to the present embodiment, and changes in design within a range not departing the gist of the present invention are included in the present invention. For example, in the previously described embodiment, the whole of the first cavity and the whole of the second cavity are provided on the lower mold side, but configurations are not limited to this, and an upper side portion of the first cavity and an upper side portion of the second cavity may be provided in the upper mold side. In addition, in the previously described embodiment, the lower mold itself is configured to be able to move forward and backward relative to a fixed-type temperature sensor, which allows the temperature sensor to be inserted into and removed from the second cavity, but configurations are not limited to this, and the temperature sensor may be configured to be able to move forward and backward relative to a fixed lower mold, which allows the temperature sensor to be automatically inserted into and removed from the second cavity. As necessary, manual insertion and removal may be adopted in place of the automatic insertion and removal.

The test apparatus for identifying a blowing-limit vulcanization degree according to the present invention and the test method using the test apparatus are applicable not only to simulations of normal tires, but also to the study of vulcanization conditions in producing and development phase of large tires including aircraft tires, belts, rubber vibration isolators, and the like.

### REFERENCE SIGNS LIST

1 upper mold (vulcanizing mold)
2 lower mold (vulcanizing mold)
3 first cavity (cavity, specimen forming space)
4 second cavity (cavity, temperature-sensing-purpose space)
5 temperature sensor
6 temperature sensor insertion opening
7 double-shaft air cylinder (pressurization mechanism, decompression retention mechanism)
8 ascending-descending base (pressurization mechanism, decompression retention mechanism)
9 leading end portion of temperature sensor 5
10 leaf spring (spring, decompression retention mechanism)
14 upper soaking plate (part of vulcanizing mold)
15 lower soaking plate (part of vulcanizing mold)
23 unvulcanized sample rubber
24 rubber specimen

What is claimed is:

1. A vulcanizing mold for identifying a blowing-limit vulcanization degree comprising:
an upper mold and a lower mold that pair off vertically, at least the lower mold being provided with a cavity in which unvulcanized sample rubber is charged, heated, and subjected to press vulcanization, so as to be formed into a rubber specimen for blowing limit observation changing in vulcanization degree in a longitudinal direction;
a first cavity, in the cavity, for forming the rubber specimen, the first cavity changing in depth from one end side to another end side in the longitudinal direction;
a second cavity that connectedly extends from the first cavity, the second cavity being a space in which a temperature sensor is disposed to plot a temperature rise curve of the sample rubber during the vulcanization; and
a temperature sensor insertion opening that is provided in a predetermined wall portion of the second cavity, the temperature sensor insertion opening allowing the temperature sensor to be disposed at a predetermined temperature-sensing site in the second cavity from an outside, in an insertable and removable manner.

2. The vulcanizing mold for identifying a blowing-limit vulcanization degree of claim 1, wherein
the first cavity is set so as to gradually increase in depth from the one end side to the other end side in the longitudinal direction, and
the second cavity is provided connectedly to the other end of the first cavity and is set so as to have a uniform depth shallower than a deepest portion of the first cavity and deeper than a shallowest portion of the first cavity.

3. The vulcanizing mold for identifying a blowing-limit vulcanization degree of claim 1, wherein
the predetermined temperature-sensing site in the second cavity is set at or in a vicinity of a center part in a depth direction of the second cavity, and when the temperature sensor is disposed in the second cavity via the temperature sensor insertion opening, a hot junction of the temperature sensor is positioned in the temperature-sensing site.

4. The vulcanizing mold for identifying a blowing-limit vulcanization degree of claim 2, wherein
the predetermined temperature-sensing site in the second cavity is set at or in a vicinity of a center part in a depth direction of the second cavity, and when the temperature sensor is disposed in the second cavity via the temperature sensor insertion opening, a hot junction of the temperature sensor is positioned in the temperature-sensing site.

5. A test apparatus for identifying a blowing-limit vulcanization degree comprising:
the vulcanizing mold for identifying a blowing-limit vulcanization degree of claim 1, wherein
the rubber specimen for blowing limit observation is obtained from the first cavity of the vulcanizing mold, the rubber specimen continuously changing in degree of blowing, associated with a vulcanization degree, in a longitudinal direction, and temperature rise curve data on the sample rubber during vulcanization is acquired from the second cavity,
the test apparatus further comprising:
a pressurization mechanism that causes the upper mold to descend and tightly fit with the lower mold, and heats unvulcanized sample rubber fluidized and charged into the first cavity and the second cavity to perform press vulcanization; and
a temperature sensor that is disposed at a predetermined temperature-sensing site in the second cavity via the temperature sensor insertion opening in an insertable and removable manner and configured to plot a temperature rise curve of the sample rubber during the vulcanization.

6. A test apparatus for identifying a blowing-limit vulcanization degree comprising:
the vulcanizing mold for identifying a blowing-limit vulcanization degree of claim 2, wherein
the rubber specimen for blowing limit observation is obtained from the first cavity of the vulcanizing mold, the rubber specimen continuously changing in degree of blowing, associated with a vulcanization degree, in a longitudinal direction, and temperature rise curve data on the sample rubber during vulcanization is acquired from the second cavity,
the test apparatus further comprising:
a pressurization mechanism that causes the upper mold to descend and tightly fit with the lower mold, and heats unvulcanized sample rubber fluidized and charged into the first cavity and the second cavity to perform press vulcanization; and
a temperature sensor that is disposed at a predetermined temperature-sensing site in the second cavity via the temperature sensor insertion opening in an insertable and removable manner and configured to plot a temperature rise curve of the sample rubber during the vulcanization.

7. A test apparatus for identifying a blowing-limit vulcanization degree comprising:
the vulcanizing mold for identifying a blowing-limit vulcanization degree of claim 3, wherein
the rubber specimen for blowing limit observation is obtained from the first cavity of the vulcanizing mold, the rubber specimen continuously changing in degree of blowing, associated with a vulcanization degree, in a longitudinal direction, and temperature rise curve data on the sample rubber during vulcanization is acquired from the second cavity,
the test apparatus further comprising:
a pressurization mechanism that causes the upper mold to descend and tightly fit with the lower mold, and heats unvulcanized sample rubber fluidized and charged into the first cavity and the second cavity to perform press vulcanization; and
a temperature sensor that is disposed at a predetermined temperature-sensing site in the second cavity via the temperature sensor insertion opening in an insertable and removable manner and configured to plot a temperature rise curve of the sample rubber during the vulcanization.

8. The test apparatus for identifying a blowing-limit vulcanization degree of claim 5, further comprising:
a decompression retention mechanism configured to, after the sample rubber is subjected to the press vulcanization for a predetermined time period, release a pressure of the pressurization mechanism to atmospheric pressure, thereby retaining a decompressed state in which the upper mold is slightly lifted up by reaction force accumulated in a spring by the pressurization, wherein
the rubber specimen is taken out from the vulcanizing mold after an end of the retention of the decompressed state by the decompression retention mechanism.

9. The test apparatus for identifying a blowing-limit vulcanization degree of claim 6, further comprising:
a decompression retention mechanism configured to, after the sample rubber is subjected to the press vulcanization for a predetermined time period, release a pressure of the pressurization mechanism to atmospheric pressure, thereby retaining a decompressed state in which the upper mold is slightly lifted up by reaction force accumulated in a spring by the pressurization, wherein
the rubber specimen is taken out from the vulcanizing mold after an end of the retention of the decompressed state by the decompression retention mechanism.

10. The test apparatus for identifying a blowing-limit vulcanization degree of claim 7, further comprising:
a decompression retention mechanism configured to, after the sample rubber is subjected to the press vulcanization for a predetermined time period, release a pressure of the pressurization mechanism to atmospheric pressure, thereby retaining a decompressed state in which the upper mold is slightly lifted up by reaction force accumulated in a spring by the pressurization, wherein
the rubber specimen is taken out from the vulcanizing mold after an end of the retention of the decompressed state by the decompression retention mechanism.

11. The test apparatus for identifying a blowing-limit vulcanization degree of claim 8, further comprising:
the lower mold that is allowed to move in a horizontal direction relative to the temperature sensor by a predetermined drive mechanism, wherein
forward movement of the lower mold toward the temperature sensor causes the temperature sensor to be disposed in the second cavity via the temperature sensor insertion opening, and backward movement of the lower mold relative to the temperature sensor causes the temperature sensor to be removed out from the second cavity.

12. The test apparatus for identifying a blowing-limit vulcanization degree of claim 9, further comprising:
the lower mold that is allowed to move in a horizontal direction relative to the temperature sensor by a predetermined drive mechanism, wherein
forward movement of the lower mold toward the temperature sensor causes the temperature sensor to be disposed in the second cavity via the temperature sensor insertion opening, and backward movement of the lower mold relative to the temperature sensor causes the temperature sensor to be removed out from the second cavity.

13. The test apparatus for identifying a blowing-limit vulcanization degree of claim 10, further comprising:
the lower mold that is allowed to move in a horizontal direction relative to the temperature sensor by a predetermined drive mechanism, wherein
forward movement of the lower mold toward the temperature sensor causes the temperature sensor to be disposed in the second cavity via the temperature sensor insertion opening, and backward movement of the lower mold relative to the temperature sensor causes the temperature sensor to be removed out from the second cavity.

14. The test apparatus for identifying a blowing-limit vulcanization degree of claim 8, further comprising:
the temperature sensor that is allowed to move in the horizontal direction relative to the lower mold, wherein
with forward movement of the temperature sensor toward the vulcanizing mold, the temperature sensor is disposed in the second cavity via the temperature sensor insertion opening, and with backward movement relative to the vulcanizing mold, the temperature sensor is removed out from the second cavity.

15. The test apparatus for identifying a blowing-limit vulcanization degree of claim 9, further comprising:
the temperature sensor that is allowed to move in the horizontal direction relative to the lower mold, wherein
with forward movement of the temperature sensor toward the vulcanizing mold, the temperature sensor is disposed in the second cavity via the temperature sensor insertion opening, and with backward movement relative to the vulcanizing mold, the temperature sensor is removed out from the second cavity.

16. The test apparatus for identifying a blowing-limit vulcanization degree of claim 10, further comprising:
the temperature sensor that is allowed to move in the horizontal direction relative to the lower mold, wherein
with forward movement of the temperature sensor toward the vulcanizing mold, the temperature sensor is disposed in the second cavity via the temperature sensor insertion opening, and with backward movement relative to the vulcanizing mold, the temperature sensor is removed out from the second cavity.

17. The test apparatus for identifying a blowing-limit vulcanization degree of claim 8, further comprising:
a temperature sensor that includes a rod-shaped thermocouple temperature sensor including a hot junction at a tapered leading end portion of the thermocouple temperature sensor; and
a cooling mechanism that cools the temperature sensor being removed out from the second cavity.

18. The test apparatus for identifying a blowing-limit vulcanization degree of claim 9, further comprising:
a temperature sensor that includes a rod-shaped thermocouple temperature sensor including a hot junction at a tapered leading end portion of the thermocouple temperature sensor; and
a cooling mechanism that cools the temperature sensor being removed out from the second cavity.

19. The test apparatus for identifying a blowing-limit vulcanization degree of claim 10, further comprising:
a temperature sensor that includes a rod-shaped thermocouple temperature sensor including a hot junction at a tapered leading end portion of the thermocouple temperature sensor; and
a cooling mechanism that cools the temperature sensor being removed out from the second cavity.

20. The test apparatus for identifying a blowing-limit vulcanization degree of claim 11, further comprising:
a temperature sensor that includes a rod-shaped thermocouple temperature sensor including a hot junction at a tapered leading end portion of the thermocouple temperature sensor; and
a cooling mechanism that cools the temperature sensor being removed out from the second cavity.
